(19) United States
(12) Patent Application Publication
(10) Pub. No.: US 2023/0332784 A1
(43) Pub. Date: Oct. 19, 2023

(54) AIR PURIFIER

(71) Applicant: SAMSUNG ELECTRONICS CO., LTD., Suwon-si (KR)

(72) Inventors: Jun HWANG, Suwon-si (KR); Hyungjin KWON, Suwon-si (KR); Kyutae park, Suwon-si (KR); Nayeong BYEON, Suwon-si (KR); Joonho YOON, Suwon-si (KR); Sangwoo LEE, Suwon-si (KR); Eunsung JO, Suwon-si (KR); Hyeongkyu CHO, Suwon-si (KR); Youngju JOO, Suwon-si (KR)

(73) Assignee: SAMSUNG ELECTRONICS CO., LTD., Suwon-si (KR)

(21) Appl. No.: 18/213,102

(22) Filed: Jun. 22, 2023

Related U.S. Application Data
(63) Continuation of application No. PCT/KR22/00870, filed on Jan. 18, 2022.

(30) Foreign Application Priority Data
Feb. 23, 2021 (KR) 10-2021-0024349

(51) Int. Cl. F24F 8/80; F24F 13/28

(52) U.S. Cl. CPC F24F 8/80; F24F 13/28; F24F 2221/36

(57) ABSTRACT

An air cleaner including a first air cleaning module including a first body, a first suctioner disposed at a lower portion of the first body, and a first discharger disposed at an upper portion of the first body, wherein the first discharger discharges air that entered into the first suctioner and then passed through a first filter module, and a second air cleaning module configured to be detachably coupled to an upper end of the first air cleaning module and include a second body, a second suctioner disposed at an upper portion of the second body, and a second discharger disposed at a lower portion of the second body, wherein the second discharger discharges air that entered into the second suctioner and then passed through a second filter, a direction from a position at which the first suctioner is disposed toward a position at which the first discharger is disposed is provided as a first arrangement direction, and a second arrangement direction, that is a direction from a position at which the second suctioner is disposed toward a position at which the second discharger is disposed, is provided to be the direction opposite to the first arrangement direction.

### CROSS-REFERENCE TO RELATED APPLICATION(S)

This application is a Bypass Continuation Application of PCT International Application No. PCT/KR2022/000870, filed on Jan. 18, 2022, which is based on and claims priority to Korean Patent Application No. 10-2021-0024349, filed on Feb. 23, 2021, in the Korean Intellectual Property Office, the disclosure of which are incorporated by reference herein in their entireties.

### BACKGROUND

### 1. Field

The disclosure relates to an air cleaner, and more particularly, to a stacking structure of an air cleaner having a plurality of air cleaning modules.

### 2. Description of Related Art

An air cleaner is a device used to remove contaminants from air. The air cleaner may remove bacteria, viruses, molds, particulates, and odor-causing chemicals present in the suctioned air.

A filter configured to purify contaminated indoor air may be provided in the air cleaner. Air suctioned into the air cleaner may be purified into clean air as contaminants are removed from the air while the air passes through the filter, and the purified air may be discharged to the outside of the air cleaner.

Air cleaners may be used in various indoor spaces. An indoor space may be relatively large or small. Accordingly, air cleaners of various capacities have been released, and a user may select and buy an air cleaner having a capacity suitable to the user in consideration of an indoor living space.

However, in the case of a living space having both a small indoor space and a large indoor space, it is difficult to meet user needs using only any one of a small-capacity air cleaner and a large-capacity air cleaner. Placing multiple small-capacity air cleaners may be taken into consideration, but in a case in which multiple air cleaners are used in a single large indoor space, an area occupied by the air cleaners is too large. In a case in which a large-capacity air cleaner is placed, it is not possible to simultaneously purify air in a small indoor space and a large indoor space.

### SUMMARY

Provided is an air cleaner capable of minimizing airflow interference between adjacent air cleaning modules.

Additional aspects will be set forth in part in the description which follows and, in part, will be apparent from the description, or may be learned by practice of the presented embodiments.

An air cleaner according to a spirit of the present disclosure includes: a first air cleaning module including a first body, a first suctioner provided at a lower portion of the first body, and a first discharger provided at an upper portion of the first body, wherein the first discharger discharges air that entered into the first suctioner and then passed through a first filter module; and a second air cleaning module configured to be detachably coupled to an upper end of the first air cleaning module and include a second body, a second suctioner provided at an upper portion of the second body, and a second discharger provided at a lower portion of the second body, wherein the second discharger discharges air that entered into the second suctioner and then passed through a second filter module, wherein a direction from a position at which the first suctioner is disposed toward a position at which the first discharger is disposed is a first arrangement direction, and a second arrangement direction, which is a direction from a position at which the second suctioner is disposed toward a position at which the second discharger is disposed, is provided to be the direction opposite to the first arrangement direction.

The first suctioner may be provided along a circumference of the first body and suction air inward in a radial direction within a 360° range toward an inside of the first body.

The first discharger may be provided along the circumference of the first body and discharge air outward in the radial direction within the 360° range toward an outside of the first body.

The second suctioner may be provided along a circumference of the second body and suction air inward in the radial direction within the 360° range toward an inside of the second body.

The second discharger may be provided along the circumference of the second body and discharge air outward in the radial direction within the 360° range toward an outside of the second body.

The first body may further include a first fan module.

The first filter module may be provided at the lower portion of the first body to correspond to the first suctioner.

The first fan module may be provided at the upper portion of the first body to correspond to the first discharger.

The second body may further include a second fan module.

The second filter module may be provided at the upper portion of the second body to correspond to the second suctioner.

The second fan module may be provided at the lower portion of the second body to correspond to the second discharger.

The first filter module may include a cylindrical filter member including a hollow formed along a central axis thereof and a plate-shaped filter member configured to have a first surface provided to cover one side of the hollow.

Air introduced through a second surface of the plate-shaped filter member, the second surface of the plate-shaped filter member is disposed in a direction opposite to the first surface thereof, may pass through the hollow and flow to the second fan module.

The central axis of the cylindrical filter member may be disposed parallel to a direction in which the first suctioner and the first discharger are disposed and may allow air introduced into the first suctioner to, from an outer side surface of the cylindrical filter member, pass through the hollow and flow to the first fan module.

The first filter module may include a first filter frame provided to surround side surfaces of the plate-shaped filter member and the cylindrical filter member and couple the plate-shaped filter member and the cylindrical filter member to each other.

The second filter module may include a cylindrical filter member including a hollow formed along a central axis thereof.

The central axis of the cylindrical filter member may be disposed parallel to a direction in which the second suctioner and the second discharger are disposed and may allow air introduced into the second suctioner to, from an outer side surface of the cylindrical filter member, pass through the hollow and flow to the second fan module.

The cylindrical filter member may be provided as a plurality of cylindrical filter members.

The second filter module may include a second filter frame provided to surround side surfaces of the plurality of cylindrical filter members and couple the plurality of cylindrical filter members to each other.

The first filter module and the first fan module may be coupled to constitute the first body.

The first air cleaning module may include a first case configured to surround a side surface of the first body, in which the first filter module and the first fan module are coupled, to form an exterior of the first air cleaning module and including a first suction port corresponding to the first suctioner and a first discharge port corresponding to the first discharger.

The second filter module and the second fan module may be coupled to constitute the second body.

The second air cleaning module may include a second case configured to surround a side surface of the second body, in which the second filter module and the second fan module are coupled, to form an exterior of the second air cleaning module and including a second suction port corresponding to the second suctioner and a second discharge port corresponding to the second discharger.

The air cleaner may further include: a third air cleaning module including a third body, a third suctioner provided at a lower portion of the third body, and a third discharger provided at an upper portion of the third body, wherein the third discharger discharges air that entered into the third suctioner and then passed through a third filter module; and a fourth air cleaning module configured to be detachably coupled to an upper end of the third air cleaning module and include a fourth body, a fourth suctioner provided at an upper portion of the fourth body, and a fourth discharger provided at a lower portion of the fourth body, wherein the fourth discharger discharges air that entered into the fourth suctioner and then passed through a fourth filter module.

The third air cleaning module may be detachably coupled to an upper end of the second air cleaning module.

A third arrangement direction, which is a direction from a position at which the third suctioner is disposed toward a position at which the third discharger is disposed, may be provided to be a direction from a bottom of the air cleaner toward a top thereof.

A fourth arrangement direction, which is a direction from a position at which the fourth suctioner is disposed toward a position at which the fourth discharger is disposed, may be provided to be opposite to the third arrangement direction.

The third suctioner may be provided along a circumference of the third body and suction air inward in the radial direction within the 360° range toward an inside of the third body.

The third discharger may be provided along the circumference of the third body and discharge air outward in the radial direction within the 360° range toward an outside of the third body.

The fourth suctioner may be provided along a circumference of the fourth body and suction air inward in the radial direction within the 360° range toward an inside of the fourth body.

The fourth discharger may be provided along the circumference of the fourth body and discharge air outward in the radial direction within the 360° range toward an outside of the fourth body.

At least one of the first body, the second body, the third body, and the fourth body may be provided in a cylindrical shape.

The cylindrical shape may be provided so that circular surfaces facing each other are disposed in an up-down direction.

Fans used in the first fan module, the second fan module, the third fan module, and the fourth fan module may be provided as centrifugal fans.

Any one of the first fan module, the second fan module, the third fan module, and the fourth fan module may include a housing opening configured to allow air to be introduced through a front surface of the fan and a fan housing configured to surround and support a circumferential portion of the fan and may further include a fan motor configured to be disposed at a rear surface of the fan and rotate the fan and an electronic module configured to be fixed to an inside of the fan housing.

The air cleaner may further include a module base configured to support a lower end of the first air cleaning module.

The module base may include a base plate configured to face the second surface of the plate-shaped filter member of the first filter module and a base wall configured to extend from an edge of the base plate and provided in a cylindrical shape surrounding a side surface of the lower end of the first air cleaning module.

The base plate may include a base opening configured to allow air to be introduced through the second surface.

The first arrangement direction may be provided to be the direction from the bottom of the air cleaner toward the top thereof.

According to the spirit of the present disclosure, in an air cleaner including a plurality of air cleaning modules, an arrangement direction, which is a direction from a position at which a suctioner is disposed toward a position at which a discharger is disposed, of one air cleaning module and an arrangement direction of another air cleaning module are provided to be opposite to each other, and thus airflow interference between adjacent air cleaning modules can be minimized.

### BRIEF DESCRIPTION OF DRAWINGS

The above and other aspects and features of certain embodiments of the present disclosure will be more apparent from the following description taken in conjunction with the accompanying drawings, in which:

FIG. 1 is a view illustrating an air cleaner according to one embodiment of the present disclosure.

FIG. 2 is a lateral view of the air cleaner according to one embodiment of the present disclosure.

FIG. 3 is an exploded lateral view of first to fourth air cleaning modules of the air cleaner according to one embodiment of the present disclosure.

FIG. 4 is an exploded perspective view of the first air cleaning module of the air cleaner according to one embodiment of the present disclosure.

FIG. 5 is an exploded perspective view of the second air cleaning module of the air cleaner according to one embodiment of the present disclosure.

FIG. 6 is an exploded perspective view of a fan module of the air cleaner according to one embodiment of the present disclosure.

FIG. 7 is an exploded perspective view of a first filter module of the air cleaner according to one embodiment of the present disclosure.

FIG. 8 is a cross-sectional view of the first air cleaning module of the air cleaner according to one embodiment of the present disclosure.

FIG. 9 is an exploded perspective view of a second filter module of the air cleaner according to one embodiment of the present disclosure.

FIG. 10 is a cross-sectional view of the second air cleaning module of the air cleaner according to one embodiment of the present disclosure.

FIG. 11 is a lateral cross-sectional view of the air cleaner according to one embodiment of the present disclosure.

FIG. 12 is an enlarged view of areas A of FIG. 11.

FIG. 13 is a perspective view of a coupling module of the air cleaner according to one embodiment of the present disclosure.

FIG. 14 is an exploded perspective view of the coupling module of the air cleaner according to one embodiment of the present disclosure.

FIG. 15 is an enlarged view of area B of FIG. 11.

FIG. 16 is a cross-sectional view of a state in which, in FIG. 11, the second air cleaning module and the third air cleaning module are each separated from the coupling module.

FIG. 17 is a cross-sectional view of a base module and a portion of the first air cleaning module of the air cleaner according to one embodiment of the present disclosure.

FIG. 18 is a perspective view of the base module of the air cleaner according to one embodiment of the present disclosure.

### DETAILED DESCRIPTION

Embodiments described herein and configurations illustrated in the drawings are merely exemplary embodiments of the present disclosure, and various modifications which may replace the embodiments and the drawings herein may be present at the time of filing this application.

Also, like reference numerals or symbols presented in the drawings of the application indicate parts or elements that perform substantially the same functions.

Also, terms used herein are for describing the embodiments and are not intended to limit and/or restrict the disclosure. A singular expression includes a plural expression unless context clearly indicates otherwise. In the application, terms such as “include” or “have” are for designating that features, numbers, steps, operations, elements, parts, or combinations thereof are present, and do not preclude the possibility of presence or addition of one or more other features, numbers, steps, operations, elements, parts, or combinations thereof in advance.

Also, terms including ordinals such as “first” and “second” used herein may be used to describe various elements, but the elements are not limited by the terms, and the terms are only used for the purpose of distinguishing one element from another element. For example, a first element may be referred to as a second element while not departing from the scope of rights of the present disclosure, and likewise, a second element may also be referred to as a first element. The term “and/or” includes a combination of a plurality of associated listed items or any one item among the plurality of associated listed items.

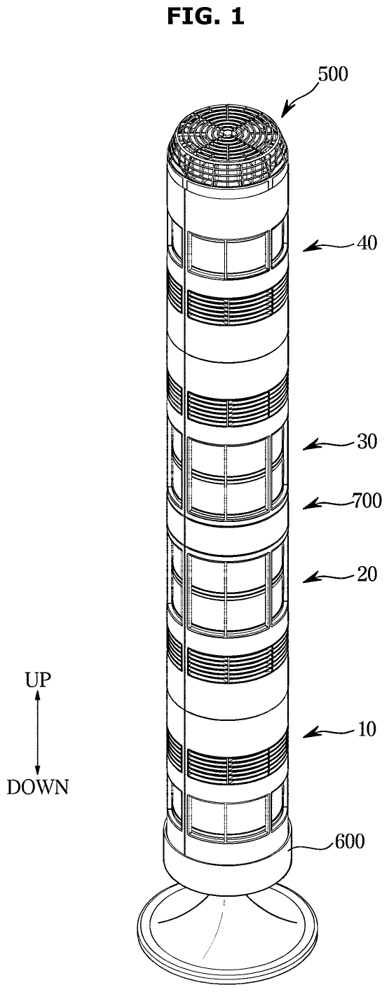

Meanwhile, terms such as “upper portion,” “lower portion,” “upper end,” “lower end,” “upper surface,” and “lower surface” used in the following description are defined based on FIG. 1, and the shape and position of each element are not limited by the terms.

Also, although a fan described below is described as being applied to a ceiling-type air conditioner as an example, the fan may also be applied to other types of air conditioners such as a stand-type air conditioner or a wall-mounted air conditioner and may also be applied to other home appliances such as a refrigerator or a vacuum cleaner.

Hereinafter, embodiments according to the present disclosure will be described in detail with reference to the accompanying drawings.

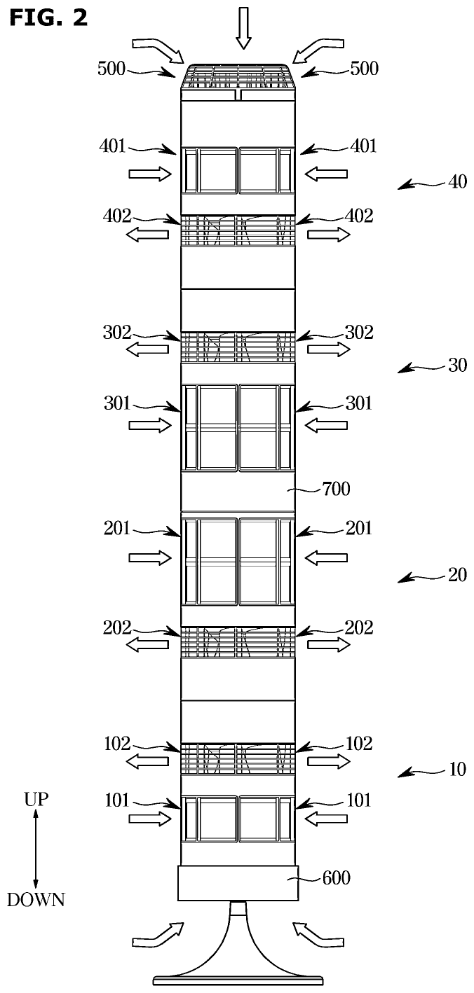

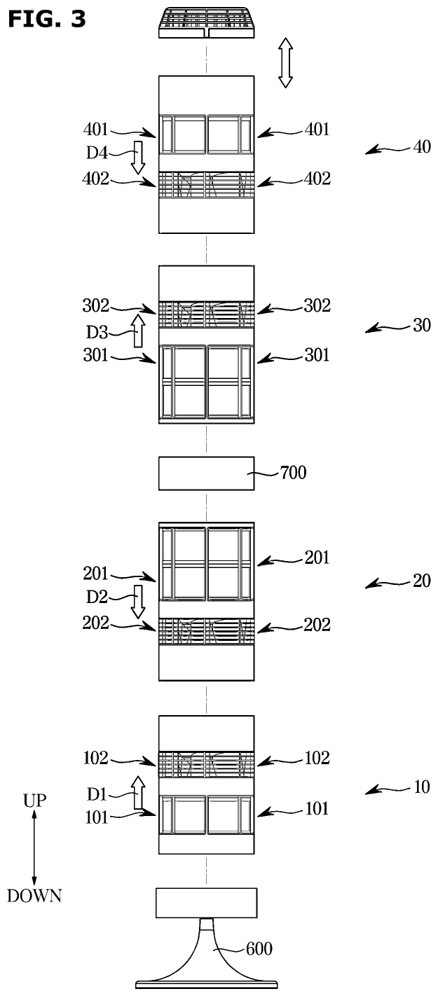

FIG. 1 is a view illustrating an air cleaner according to one embodiment of the present disclosure. FIG. 2 is a lateral view of the air cleaner according to one embodiment of the present disclosure. FIG. 3 is an exploded lateral view of first to fourth air cleaning modules of the air cleaner according to one embodiment of the present disclosure.

As illustrated in FIGS. 1 to 3, according to one embodiment of the present disclosure, an air cleaner 1 may include a first air cleaning module 10, a second air cleaning module 20, a third air cleaning module 30, and a fourth air cleaning module 40.

Although four air cleaning modules are described below as an example, the disclosure is not limited to four air cleaning modules. More than four or fewer than four air cleaning modules may be used.

A suctioner configured to suction air and a discharger configured to discharge filtered air are formed in each of the plurality of air cleaning modules, and directions from positions at which the suctioners are disposed toward positions at which the dischargers are disposed are defined below as “arrangement directions D1, D2, D3, and D4.”

In other words, a direction from a position at which a first suctioner 101 is disposed toward a position at which a first discharger 102 is disposed may be defined as a first arrangement direction D1, a direction from a position at which a second suctioner 201 is disposed toward a position at which a second discharger 202 is disposed may be defined as a second arrangement direction D2, a direction from a position at which a third suctioner 301 is disposed toward a position at which a third discharger 302 is disposed may be defined as a third arrangement direction D3, and a direction from a position at which a fourth suctioner 401 is disposed toward a position at which a fourth discharger 402 is disposed may be defined as a fourth arrangement direction D4.

Also, hereinafter, since the first air cleaning module 10 and the fourth air cleaning module 40 only differ in terms of the arrangement directions and are identical in terms of the configurations and shapes thereof, only the first air cleaning module 10 will be described except for describing the arrangement direction or the coupling or separation structure between the air cleaning modules.

When describing each configuration of the first air cleaning module 10, each configuration will also be denoted by a reference numeral of a configuration of the fourth air cleaning module 40 that is the same as the corresponding configuration of the first air cleaning module 10. For example, the term “first air cleaning module” will be denoted by reference numerals 10 and 40, and the term “first body” will be denoted by reference numerals 100 and 400 below.

Likewise, since the second air cleaning module 20 and the third air cleaning module 30 only differ in terms of the arrangement directions and are identical in terms of the configurations and shapes thereof, only the second air cleaning module 20 will be described except for describing the coupling or separation structure between the air cleaning modules.

When describing each configuration of the second air cleaning module 20, each configuration will also be denoted by a reference numeral of a configuration of the third air cleaning module 30 that is the same as the corresponding configuration of the second air cleaning module 20. For example, the term “second air cleaning module” will be denoted by reference numerals 20 and 30, and the term “second body” will be denoted by reference numerals 200 and 300 below.

Referring to FIGS. 1 to 3, the air cleaner 1 according to one embodiment of the present disclosure may include the first air cleaning module 10, the second air cleaning module 20, the third air cleaning module 30, and the fourth air cleaning module 40.

In order to improve space utilization while not increasing a floor area occupied by the air cleaner 1, the first air cleaning module 10, the second air cleaning module 20, the third air cleaning module 30, and the fourth air cleaning module 40 may be stacked in this order in an up-down direction.

The first air cleaning module 10, 40 may include a first body 100, 400, a first suctioner 101, 401 provided at a lower portion of the first body 100, 400, and a first discharger 102, 402 provided at an upper portion of the first body 100, 400.

The first air cleaning module 10 may be provided so that the direction from the position at which the first suctioner 101 is disposed toward the position at which the first discharger 102 is disposed is the first arrangement direction D1. The first arrangement direction D1 may be directed in an up direction.

The fourth air cleaning module 40 may be provided so that the direction from the position at which the fourth suctioner 401 is disposed toward the position at which the fourth discharger 402 is disposed is the fourth arrangement direction D4. The fourth arrangement direction D4 may be directed in a down direction.

The first arrangement direction D1 of the first air cleaning module 10 in the air cleaner 1 may be provided to be a direction from a bottom of the air cleaner 1 toward a top thereof based on FIG. 3.

The fourth arrangement direction D4 of the fourth air cleaning module 40 in the air cleaner 1 may be provided to be a direction from the top of the air cleaner 1 toward the bottom thereof based on FIG. 3.

The first body 100, 400 may include a first filter module 120, 420 and a first fan module 110, 410.

The first discharger 102, 402 may be provided to discharge air filtered by passing through the first filter module 120, 420 after being introduced into the first suctioner 101, 401. The first fan module 110, 410 may generate a flow of air from the first suctioner 101, 401 to the first discharger 102, 402 via the inside of the first body 100, 400.

The shape of the first body 100, 400 of the first air cleaning module 10, 40 may be provided as a cylindrical shape. However, the shape of the first air cleaning module 10, 40 is not limited thereto.

The first filter module 120, 420 and the first fan module 110, 410 may be coupled to constitute the first body 100, 400. The first filter module 120, 420 may be provided at the lower portion of the first body 100, 400 to correspond to the first suctioner 101, 401. The first fan module 110, 410 may be provided at the upper portion of the first body 100, 400 to correspond to the first discharger 102, 402.

Since the first filter module 120, 420 and the first fan module 110, 410 may be coupled to constitute the first body 100, 400, the shape of the first filter module 120, 420 may be provided as a substantially cylindrical shape, and the shape of the first fan module 110, 410 may be provided as a substantially cylindrical shape. Specific structures of the first filter module 120, 420 and the first fan module 110, 410 will be described below.

The first suctioner 101, 401 may be provided along the circumference of the first body 100, 400. The first suctioner 101, 401 may suction air inward in a radial direction within a 360° range toward the inside of the first body 100, 400.

The first discharger 102, 402 may be provided along the circumference of the first body 100, 400. The first discharger 102, 402 may discharge air outward in the radial direction within the 360° range toward the outside of the first body 100, 400.

The first air cleaning module 10, 40 may further include a first case 130, 430 configured to form an exterior thereof. The first case 130, 430 may be provided to surround a side surface of the first body 100, 400 in which the first filter module 120, 420 and the first fan module 110, 410 are coupled. Due to being provided to surround the side surface of the first body 100, 400, the first case 130, 430 may be provided in a substantially cylindrical shape. However, the shape of the first case 130, 430 is not limited thereto.

The first case 130, 430 may include a first suction port 131, 431 corresponding to the first suctioner 101, 401. The first case 130, 430 may include a first discharge port 132, 432 corresponding to the first discharger 102, 402. Air may sequentially flow through the first suction port 131, 431 of the first case 130, 430, the first suctioner 101, 401, the first filter module 120, 420, the first fan module 110, 410, the first discharger 102, 402, and the first discharge port 132, 432.

Due to being formed to correspond to the first suctioner 101, 401, the first suction port 131, 431 may be provided in a shape that is open toward the outside of the air cleaner 1 along the circumference of the first body 100, 400.

Specific structures of the first case 130, 430, the first suction port 131, 431, and the first discharge port 132, 432 will be described below.

The second air cleaning module 20, 30 may include a second body 200, 300, a second suctioner 201, 301 provided at an upper portion of the second body 200, 300, and a second discharger 202, 302 provided at a lower portion of the second body 200, 300.

The second air cleaning module 20 may be provided so that the direction from the position at which the second suctioner 201 is disposed toward the position at which the second discharger 202 is disposed is the second arrangement direction D2. The second arrangement direction D2 may be oriented in a down direction.

The third air cleaning module 30 may be provided so that the direction from the position at which the third suctioner 301 is disposed toward the position at which the third discharger 302 is disposed is the third arrangement direction D3. The third arrangement direction D3 may be oriented in an up direction.

The second arrangement direction D2 of the second air cleaning module 20 in the air cleaner 1 may be provided to be opposite to the first arrangement direction D1 based on FIG. 3. The first arrangement direction D1 and the second arrangement direction D2 may be provided to be opposite to each other. That is, the second arrangement direction D2 of the second air cleaning module 20 in the air cleaner 1 may be provided to be a direction from the top of the air cleaner 1 toward the bottom thereof based on FIG. 3, and the third arrangement direction D3 of the third air cleaning module 30 in the air cleaner 1 may be provided to be a direction from the bottom of the air cleaner 1 toward the top thereof based on FIG. 3.

Here, being “opposite” may mean that the first arrangement direction D1 and the second arrangement direction D2 are provided to be directions opposite to each other. Accordingly, between adjacent air cleaning modules, the suctioners of the air cleaning modules may be disposed adjacent to each other, or the dischargers of the air cleaning modules may be disposed adjacent to each other.

Also, the above-described meaning of being “opposite” may also identically apply to the structure in which the fourth arrangement direction D4 is provided to be the direction opposite to the third arrangement direction D3 based on FIG. 3.

The second body 200, 300 may include a second filter module 220, 320 and a second fan module 210, 310.

The second discharger 202, 302 may be provided to discharge air filtered by passing through the second filter module 220, 320 after being introduced into the second suctioner 201, 301. The second fan module 210, 310 may generate a flow of air from the second suctioner 201, 301 to the second discharger 202, 302 via the inside of the second body 200, 300.

The shape of the second body 200, 300 of the second air cleaning module 20, 30 may be provided as a cylindrical shape. However, the shape of the second air cleaning module 20, 30 is not limited thereto.

The second filter module 220, 320 and the second fan module 210, 310 may be coupled to constitute the second body 200, 300. The second filter module 220, 320 may be provided at the upper portion of the second body 200, 300 to correspond to the second suctioner 201, 301. The second fan module 210, 310 may be provided at the lower portion of the second body 200, 300 to correspond to the second discharger 202, 302.

Since the second filter module 220, 320 and the second fan module 210, 310 may be coupled to constitute the second body 200, 300, the shape of the second filter module 220, 320 may be provided as a substantially cylindrical shape, and the shape of the second fan module 210, 310 may be provided as a substantially cylindrical shape. Specific structures of the second filter module 220, 320 and the second fan module 210, 310 will be described below.

The second suctioner 201, 301 may be provided along the circumference of the second body 200, 300. The second suctioner 201, 301 may suction air inward in the radial direction within the 360° range toward the inside of the second body 200, 300.

The second discharger 202, 302 may be provided along the circumference of the second body 200, 300. The second discharger 202, 302 may discharge air outward in the radial direction within the 360° range toward the outside of the second body 200, 300.

The second air cleaning module 20, 30 may further include a second case 230, 330 configured to form an exterior thereof. The second case 230, 330 may be provided to surround a side surface of the second body 200, 300 in which the second filter module 220, 320 and the second fan module 210, 310 are coupled. Due to being provided to surround the side surface of the second body 200, 300, the second case 230, 330 may be provided in a substantially cylindrical shape. However, the shape of the second case 230, 330 is not limited thereto.

The second case 230, 330 may include a second suction port 231, 331 corresponding to the second suctioner 201, 301. The second case 230, 330 may include a second discharge port 232, 332 corresponding to the second discharger 202, 302. Air may sequentially flow through the second suction port 231, 331 of the second case 230, 330, the second suctioner 201, 301, the second filter module 220, 320, the second fan module 210, 310, the second discharger 202, 302, and the second discharge port 232, 332.

Due to being formed to correspond to the second suctioner 201, 301, the second suction port 231, 331 may be a shape that is open toward the outside of the air cleaner 1 along the circumference of the second body 200, 300.

Specific structures of the second case 230, 330, the second suction port 231, 331, and the second discharge port 232, 332 will be described below.

In a conventional air cleaner including a plurality of air cleaning modules, even when the plurality of air cleaning modules are stacked, suction ports through which air is introduced are not disposed adjacent to each other between adjacent air cleaning modules, and discharge ports through which filtered air is discharged are not disposed adjacent to each other between the adjacent air cleaning modules. In other words, the plurality of air cleaning modules are stacked such that a suction port of one air cleaning module and a discharge port of another air cleaning module adjacent to the one air cleaning module are adjacent. As a result, air purification efficiency may decrease due to airflow interference.

The air cleaner 1 according to one embodiment of the present disclosure may have the following structure to minimize airflow interference between adjacent air cleaning modules.

The second air cleaning module 20 may be detachably coupled to an upper end of the first air cleaning module 10. Specifically, when the second air cleaning module 20 is coupled to the first air cleaning module 10, the first arrangement direction D1 of the first air cleaning module 10 and the second arrangement direction D2 of the second air cleaning module 20 may be provided to be opposite to each other.

Accordingly, the air cleaner 1 according to one embodiment of the present disclosure may implement a structure in which the first discharger 102 and the second discharger 202 gather at a central portion of the coupling structure of the first air cleaning module 10 and the second air cleaning module 20. Also, since discharge airflow discharged from the first discharger 102 and discharge airflow discharged from the second discharger 202 are formed in adjacent areas, there may be an effect of focusing the two streams of airflow, and as a result, filtered air can be blown at a higher flow velocity to a purification space far away from the air cleaner 1, and thus air purification efficiency can be increased.

The first suctioner 101 or the second suctioner 201 may be disposed at each of both ends of the coupling structure of the first air cleaning module 10 and the second air cleaning module 20. Specifically, in the air cleaner 1 according to one embodiment of the present disclosure, the first suctioner 101 may be disposed at a lower end of the coupling structure of the first air cleaning module 10 and the second air cleaning module 20, and the second suctioner 201 may be disposed at an upper end of the coupling structure of the first air cleaning module 10 and the second air cleaning module 20.

The first suctioner 101 being disposed at the lower end of the coupling structure of the first air cleaning module 10 and the second air cleaning module 20 in the air cleaner 1 according to one embodiment of the present disclosure is a result of taking into consideration the characteristic of the purification space that contaminated air is highly likely to stay in a lower area, particularly an area adjacent to the floor, of the purification space. The air cleaner 1 according to one embodiment of the present disclosure may be provided to suction contaminated air from the lower area of the purification space and discharge filtered air to a relatively higher position and thus may increase the purification efficiency.

As described above, the first air cleaning module 10 and the fourth air cleaning module 40 only differ in terms of the arrangement directions and are identical in terms of the configurations and shapes thereof, and the second air cleaning module 20 and the third air cleaning module 30 only differ in terms of the arrangement directions and are identical in terms of the configurations and shapes thereof.

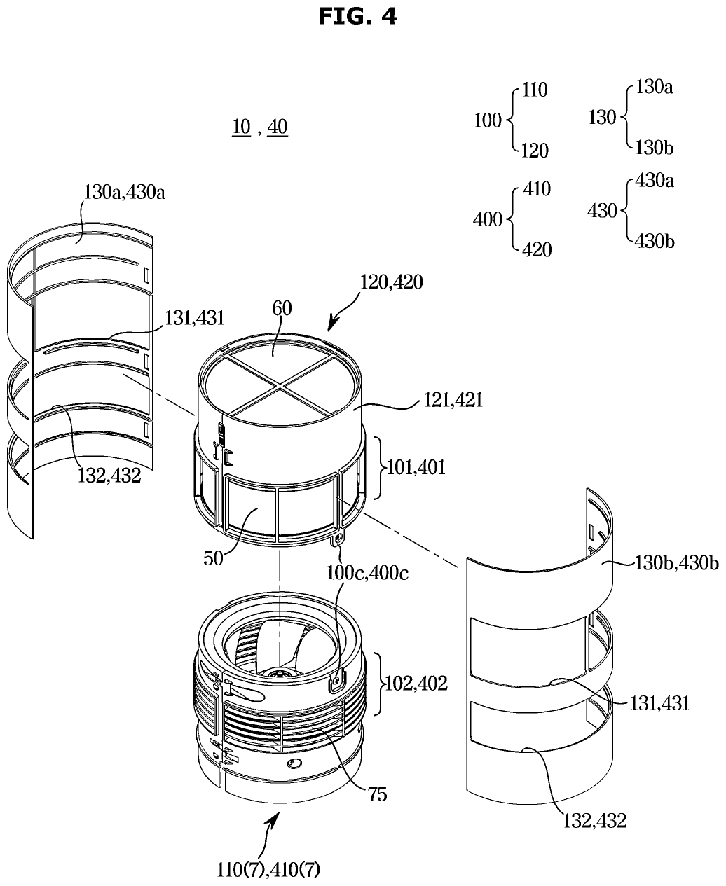

Referring to FIGS. 4 to 10, the structure of the third air cleaning module 30 may be provided to be identical to the structure of the second air cleaning module 20. However, in the air cleaner 1, the third arrangement direction D3 of the third air cleaning module 30 may be provided to be opposite to the second arrangement direction D2 of the second air cleaning module 20. Accordingly, the third air cleaning module 30 may be provided in a shape obtained by flipping the second air cleaning module 20 in the up-down direction.

The structure of the fourth air cleaning module 40 may be provided to be identical to the structure of the first air cleaning module 10. However, the fourth arrangement direction D4 of the fourth air cleaning module 40 may be provided to be opposite to the first arrangement direction D1 of the first air cleaning module 10. Accordingly, the fourth air cleaning module 40 may be provided in a shape obtained by flipping the first air cleaning module 10 in the up-down direction.

The fourth air cleaning module 40 may be detachably coupled to an upper end of the third air cleaning module 30. Specifically, when the fourth air cleaning module 40 is coupled to the third air cleaning module 30, the fourth arrangement direction D4 of the fourth air cleaning module 40 and the third arrangement direction D3 of the third air cleaning module 30 may be provided to be opposite to each other.

Accordingly, the air cleaner 1 according to one embodiment of the present disclosure may implement a structure in which the third discharger 302 and the fourth discharger 402 are disposed at a central portion of the coupling structure of the third air cleaning module 30 and the fourth air cleaning module 40. Also, since discharge airflow discharged from the third discharger 302 and discharge airflow discharged from the fourth discharger 402 are formed in adjacent areas, there may be an effect of focusing the two streams of airflow, and as a result, filtered air can be blown at a higher flow velocity to a purification space far away from the air cleaner 1, and thus air purification efficiency can be increased.

The third suctioner 301 or the fourth suctioner 401 may be disposed at each of both ends of the coupling structure of the third air cleaning module 30 and the fourth air cleaning module 40. Specifically, in the air cleaner 1 according to one embodiment of the present disclosure, the third suctioner 301 may be disposed at a lower end of the coupling structure of the third air cleaning module 30 and the fourth air cleaning module 40, and the fourth suctioner 401 may be disposed at an upper end of the coupling structure of the third air cleaning module 30 and the fourth air cleaning module 40.

Referring to FIGS. 1 to 3 and FIG. 8, the third air cleaning module 30 may be detachably coupled to an upper end of the second air cleaning module 20. As a result, the coupling structure of the first air cleaning module 10 and the second air cleaning module 20 corresponds to a structure in which the two air cleaning modules are stacked in the up-down direction and thus can purify the purification space across a larger area. Also, the second discharger 202 and the third discharger 302 may gather at a central portion of the coupling structure of the first air cleaning module 10 to the fourth air cleaning module 40. Since, due to the above structure, suction airflow introduced into the second suctioner 201 and suction airflow introduced into the third suctioner 301 are formed in adjacent areas, there may be an effect of focusing the two streams of airflow, and contaminants in the purification space can be more promptly suctioned into the air cleaner 1.

The air cleaner 1 may further include an auxiliary air blower module 500. Referring to FIGS. 1 to 3, the auxiliary air blower module 500 may be coupled to an upper end of the fourth air cleaning module 40. The auxiliary air blower module 500 may form blowing airflow so that air is rapidly introduced into a fourth body 400 of the fourth air cleaning module 40.

The air cleaner 1 may further include a module base 600. The module base 600 may support a lower end of the first air cleaning module 10. A specific structure of the module base 600 will be described below.

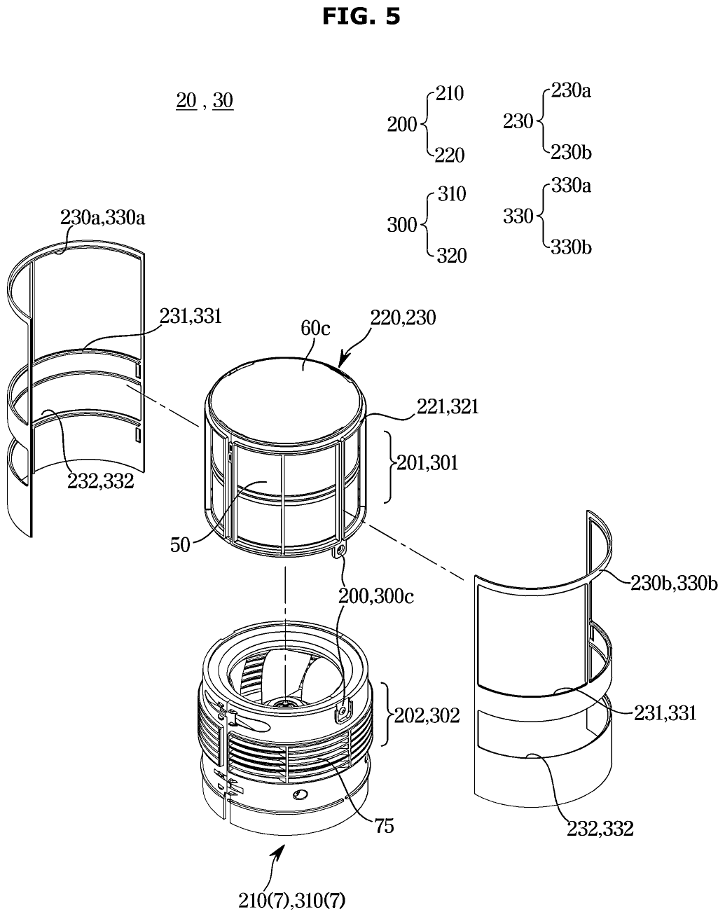

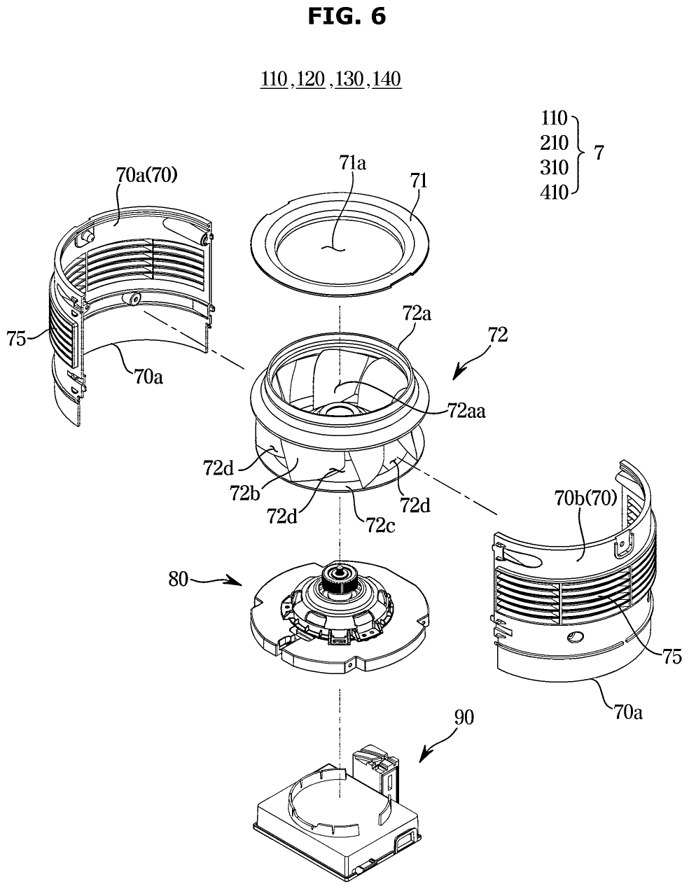

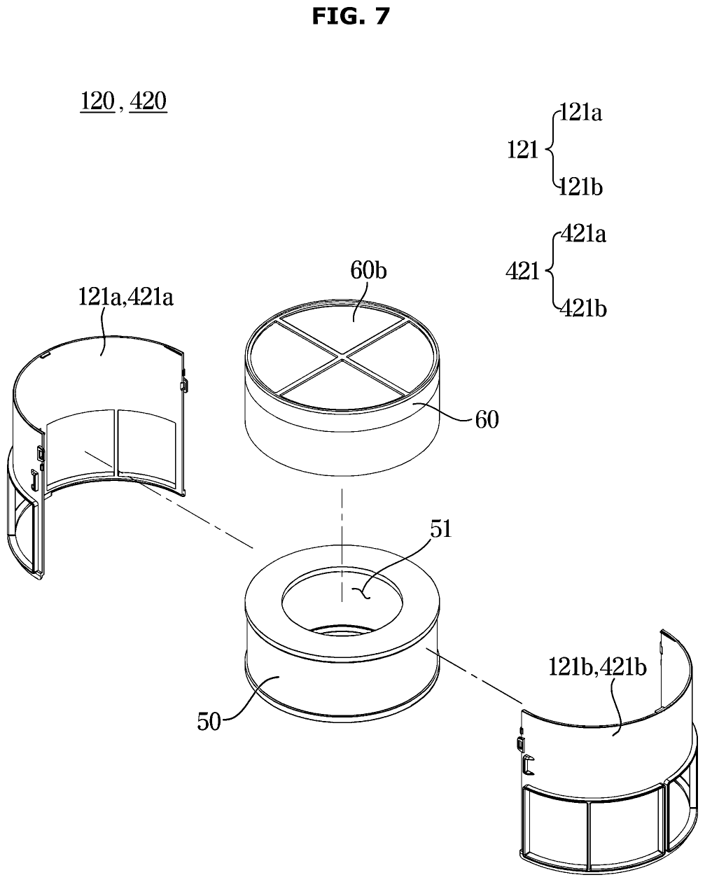

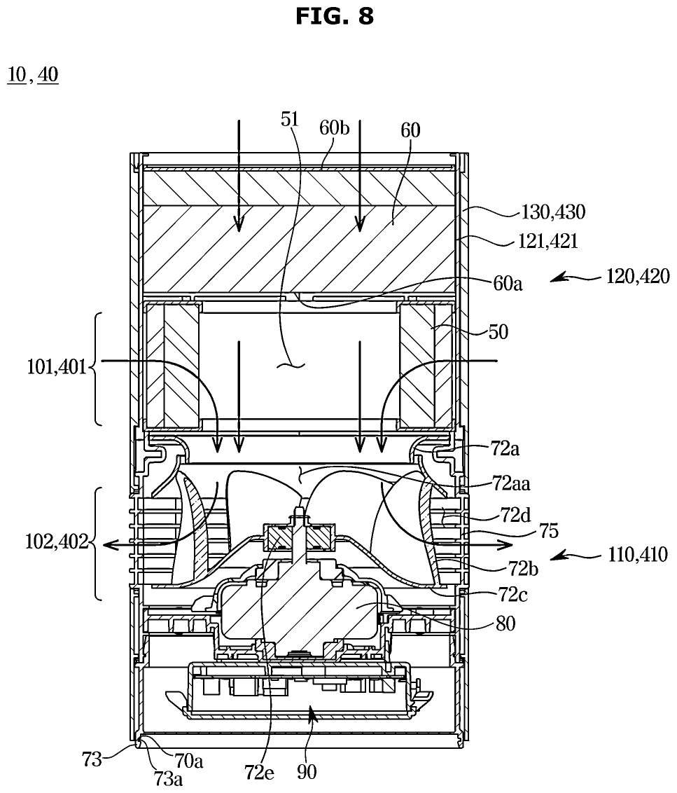

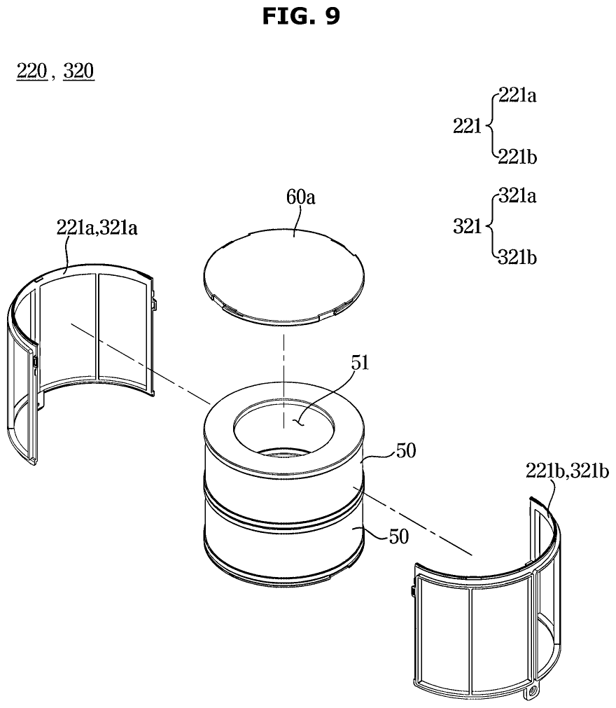

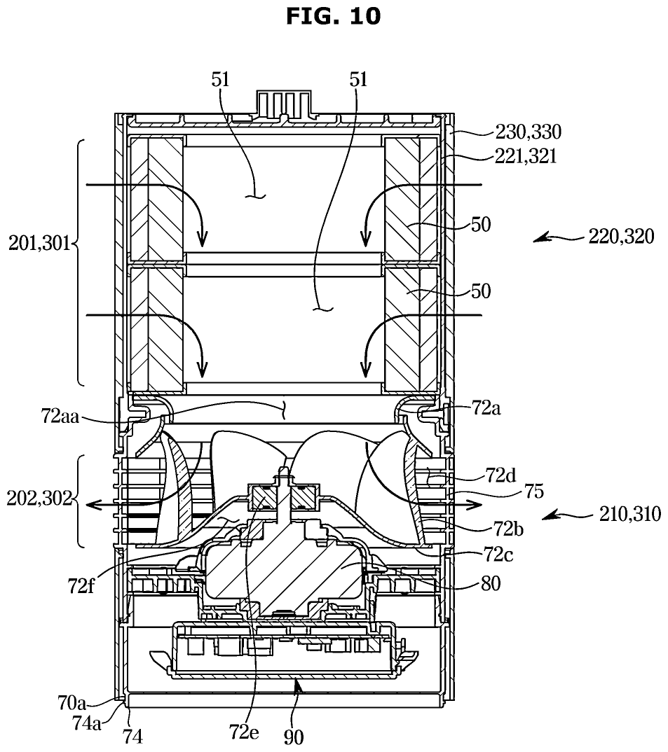

FIG. 4 is an exploded perspective view of the first air cleaning module of the air cleaner according to one embodiment of the present disclosure. FIG. 5 is an exploded perspective view of the second air cleaning module of the air cleaner according to one embodiment of the present disclosure. FIG. 6 is an exploded perspective view of a fan module of the air cleaner according to one embodiment of the present disclosure. FIG. 7 is an exploded perspective view of a first filter module of the air cleaner according to one embodiment of the present disclosure. FIG. 8 is a cross-sectional view of the first air cleaning module of the air cleaner according to one embodiment of the present disclosure. FIG. 9 is an exploded perspective view of a second filter module of the air cleaner according to one embodiment of the present disclosure. FIG. 10 is a cross-sectional view of the second air cleaning module of the air cleaner according to one embodiment of the present disclosure.

Referring to FIG. 4, the first air cleaning module 10, 40 may include the first filter module 120, 420, the first fan module 110, 410, and the first case 130, 430. The first filter module 120, 420 and the first fan module 110, 410 may be coupled to each other to form the first body 100, 400. The first filter module 120, 420 and the first fan module 110, 410 may be coupled by a fastening member 100c, 400c and form the first body 100, 400.

The first case 130, 430 may be provided to surround the side surface of the first body 100, 400 in which the first filter module 120, 420 and the first fan module 110, 410 are coupled. Due to being provided to surround the side surface of the first body 100, 400, the first case 130, 430 may be provided in a substantially cylindrical shape. However, the shape of the first case 130, 430 is not limited thereto.

For the first case 130, 430 to be easily coupled to the first body 100, 400, the first case 130, 430 may be formed by a first part 130a, 430a and a second part 130b, 430b, each having a semi-cylindrical shape, being coupled to each other. The first part 130a, 430a and the second part 130b, 430b of the first case 130, 430 may be coupled to the first body 100, 400 such that inner side surfaces of the first part 130a, 430a and the second part 130b, 430b face each other. The first case 130, 430 may be coupled to the first body 100, 400 by a hook-type fastening member or a magnetic force.

The first case 130, 430 may include the first suction port 131, 431 corresponding to the first suctioner 101, 401. The first case 130, 430 may include the first discharge port 132, 432 corresponding to the first discharger 102, 402.

The first filter module 120, 420 may be disposed to correspond to the first suctioner 101, 401, and the first fan module 110, 410 may be disposed to correspond to the first discharger 102, 402. The first suction port 131, 431 may be formed to correspond to a side surface of a cylindrical filter member 50 of the first filter module 120, 420. The first discharge port 132, 432 may be formed to correspond to a discharge grille 75 of a fan housing 70. The first suction port 131, 431 or the first discharge port 132, 432 may be provided in a shape that is open toward the outside of the air cleaner 1 along the circumference of the first body 100, 400.

Referring to FIG. 5, the second air cleaning module 20, 30 may include the second filter module 220, 320, the second fan module 210, 310, and the second case 230, 330. The second filter module 220, 320 and the second fan module 210, 310 may be coupled to each other to form the second body 200, 300. The second filter module 220, 320 and the second fan module 210, 310 may be coupled by a fastening member 200c, 300c and form the second body 200, 300.

The second case 230, 330 may be provided to surround the side surface of the second body 200, 300 in which the second filter module 220, 320 and the second fan module 210, 310 are coupled. Due to being provided to surround the side surface of the second body 200, 300, the second case 230, 330 may be provided in a substantially cylindrical shape. However, the shape of the second case 230, 330 is not limited thereto.

For the second case 230, 330 to be easily coupled to the second body 200, 300, the second case 230, 330 may be formed by a first part 230a, 330a and a second part 230b, 330b, each having a semi-cylindrical shape, being coupled to each other. The first part 230a, 330a and the second part 230b, 330b of the second case 230, 330 may be coupled to the second body 200, 300 such that inner side surfaces of the first part 230a, 330a and the second part 230b, 330b face each other. The second case 230, 330 may be coupled to the second body 200, 300 by a hook-type fastening member or a magnetic force.

The second case 230, 330 may include the second suction port 231, 331 corresponding to the second suctioner 201, 301. The second case 230, 330 may include the second discharge port 232, 332 corresponding to the second discharger 202, 302.

The second filter module 220, 320 may be disposed to correspond to the second suctioner 201, 301, and the second fan module 210, 310 may be disposed to correspond to the second discharger 202, 302. The second suction port 231, 331 may be formed to correspond to a side surface of a cylindrical filter member 50 of the second filter module 220, 320. The second discharge port 232, 332 may be formed to correspond to the discharge grille 75 of the fan housing 70. The second suction port 231, 331 or the second discharge port 232, 332 may be provided in a shape that is open toward the outside of the air cleaner 1 along the circumference of the second body 200, 300.

Referring to FIG. 6, a fan module 7 of the air cleaner 1 according to one embodiment of the present disclosure may have the same structure as the first fan module 110 of the first air cleaning module 10, the second fan module 210 of the second air cleaning module 20, the third fan module 310 of the third air cleaning module 30, and the fourth fan module 410 of the fourth air cleaning module 40.

The fan module 7 may include a fan 72, the fan housing 70, a fan motor 80, and an electronic module 90.

The fan 72 may include an inlet 72a, a blade 72b, and a base 72c. The inlet 72a, the blade 72b, and the base 72c may be integrally molded. The fan 72 may be injection-molded as one body. A direction of rotation of the base 72c coincides with a direction of rotation of the fan 72.

The inlet 72a may be formed in a substantially circular shape. The inlet 72a may have a substantially donut-like shape with an open center. The inlet 72a may form a fan entry port 72aa. Air may be introduced into the fan 72 through the fan entry port 72aa. The inlet 72a has a shape that can guide air introduced through the fan entry port 72aa to be discharged through a fan discharge port 72d. The inlet 72a may have a shape that widens outward in the radial direction toward the top.

The base 72c may have a substantially disk-like shape. The base 72c may include a fan motor accommodator 72f (see FIG. 8) positioned substantially at the center of the base 72c. Specifically, the base 72c may include a base central portion protruding toward the inlet 72a disposed in the middle. The base central portion may be provided in a substantially hollow semispherical shape. The fan motor accommodator 72f may be formed in an area of a base upper surface that corresponds to the base central portion.

A bearing 72e into which a motor shaft of the fan motor 80 is inserted may be insertion-molded at the center of the base central portion.

The fan motor accommodator 72f may be formed to accommodate the fan motor 80. The fan motor accommodator 72f may extend in a direction of an axis of rotation of the fan 72.

The fan discharge port 72d may be formed between the inlet 72a and the base 72c. The fan discharge port 72d may be formed along the circumference of the fan 72.

The blade 72b may be positioned between the inlet 72a and the base 72c. The blade 72b may extend from the base 72c to the inlet 72a. The blade 72b may be provided as a plurality of blades 72b spaced apart from each other at predetermined intervals along the circumference of the fan 72.

The fan housing 70 may be provided in a substantially cylindrical shape. The fan housing 70 may be provided to be made of two semi-cylindrical structures like the first case 130, 430 or the second case 230, 330. The fan housing 70 may include a housing opening 71a configured to allow air to be introduced through a front surface of the fan 72. The housing opening 71a may be formed at the center of an opening frame 71 having a donut shape. The fan housing 70 may be provided to surround and support a circumferential portion of the fan 72.

Since the fan discharge port 72d is formed along the circumference of the fan 72, the fan housing 70 surrounding and supporting the circumferential portion of the fan 72 may have the discharge grille 75 formed at a position corresponding to the fan discharge port 72d.

The fan housing 70 may further include the fan motor 80 disposed at a rear surface of the fan 72 and configured to rotate the fan 72 and the electronic module 90 fixed to the inside of the fan housing 70. The electronic module 90 may include a power supply (not illustrated) provided to apply voltage to the fan motor 80 and a controller (not illustrated) provided to control the operation of the first air cleaning module 10 to the fourth air cleaning module 40.

The first air cleaning module 10 to the fourth air cleaning module 40 may each include the electronic module 90. The electronic module 90 may include a power adapter (not illustrated) to apply voltage to the fan motor 80.

Referring to FIG. 2, the first air cleaning module 10 may be electrically connected to the second air cleaning module 20. The second air cleaning module 20 may be electrically connected to the third air cleaning module 30. Specifically, the second air cleaning module 20 may be electrically connected through a coupling module 700 which will be described below. However, in another embodiment the second air cleaning module 20 and the third air cleaning module 30 may be directly coupled and electrically connected without the coupling module 700. The third air cleaning module 30 may be electrically connected to the fourth air cleaning module 40.

In each of the first air cleaning module 10 to the fourth air cleaning module 40, a power connector (not illustrated) configured to be electrically connected to the power adapter (not illustrated) of the electronic module 90 may be provided at one end 70a of the fan housing 70. As will be described below, due to a coupling structure provided at the one end 70a of the fan housing 70 of each of the first air cleaning module 10 to the fourth air cleaning module 40, when adjacent air cleaning modules are coupled to each other, the power connectors (not illustrated) of the adjacent air cleaning modules may be electrically connected to each other.

When power is supplied from the outside to any one of the first air cleaning module 10 to the fourth air cleaning module 40, since the first air cleaning module 10 to the fourth air cleaning module 40 are electrically connected to one another, power that can drive the fan motor 80 of each of the air cleaning modules may be supplied as a result. The fan motor 80 of the air cleaning modules may activate even if the respective air cleaning module is not directly connected to the power supply.

Referring to FIG. 7 or 8, the first filter module 120, 420 may include the cylindrical filter member 50 and a plate-shaped filter member 60. The cylindrical filter member 50 may include a hollow 51 formed along the central axis thereof. The plate-shaped filter member 60 may be configured to have a first surface 60a provided to cover one side of the hollow. The plate-shaped filter member 60 may be provided in a substantially disk-like shape to correspond to one side of the cylindrical filter member 50. The other side of the hollow 51 not covered by the plate-shaped filter member 60 may communicate with the fan entry port 72aa of the first fan module 110, 410. The central axis of the cylindrical filter member 50 may be disposed parallel to the first arrangement direction D1 of the first air cleaning module 10.

The first filter module 120, 420 may further include a first filter frame 121, 421 configured to surround side surfaces of the plate-shaped filter member 60 and the cylindrical filter member 50 and couple the plate-shaped filter member 60 and the cylindrical filter member 50 to each other in the up-down direction.

The first filter frame 121, 421 may be provided in a substantially cylindrical shape and may have an opening formed in an area corresponding to the side surface of the cylindrical filter member 50.

Referring to FIG. 9 or 10, the second filter module 220, 320 may include the cylindrical filter member 50 including the hollow 51 formed along the central axis thereof. The cylindrical filter member 50 used in the second filter module 220, 320 may be provided to be identical to the cylindrical filter member 50 used in the first filter module 120, 420.

The second filter module 220, 320 may include a plurality of cylindrical filter members 50. The plurality of cylindrical filter members 50 may be disposed parallel to each other in the up-down direction.

The second filter module 220, 320 may further include a second filter frame 221, 321 configured to surround side surfaces of the plurality of cylindrical filter members 50 and couple the plurality of cylindrical filter members 50 to each other in the up-down direction.

The second filter frame 221, 321 may be provided in a substantially cylindrical shape and may have an opening formed in an area corresponding to the side surface of the cylindrical filter member 50.

The second filter module 220, 320 may further include a filter cover 60c provided to cover one side of the hollow 51 of the cylindrical filter member 50. The other side of the hollow 51 not covered by the filter cover 60c may communicate with the fan entry port 72aa of the second fan module 210, 310. The central axis of the cylindrical filter member 50 may be disposed parallel to the second arrangement direction D2 of the second air cleaning module 20.

Referring to FIGS. 4 and 8, air may sequentially flow through the first suction port 131, 431 of the first case 130, 430, the first suctioner 101, 401, the first filter module 120, 420, the first fan module 110, 410, the first discharger 102, 402, and the first discharge port 132, 432 in the first air cleaning module 10, 40.

Specifically, air introduced through a second surface 60b of the plate-shaped filter member 60 in a direction opposite to the first surface 60a thereof may be provided to, after being purified by passing through the hollow 51, flow to the second fan module 210, 310, and air introduced into the first suctioner 101, 401 may be provided to, after being purified by passing through the hollow 51 from an outer side surface of the cylindrical filter member 50, flow to the first fan module 110, 410.

Referring to FIGS. 5 and 10, air may sequentially flow through the second suction port 231, 331 of the second case 230, 330, the second suctioner 201, 301, the second filter module 220, 320, the second fan module 210, 310, the second discharger 202, 302, and the second discharge port 232, 332 in the second air cleaning module 20, 30.

Specifically, air introduced into the second suctioner 201, 301 may be provided to, after being purified by passing through the hollows 51 from outer side surfaces of the plurality of cylindrical filter members 50, flow to the second fan module 210, 310.

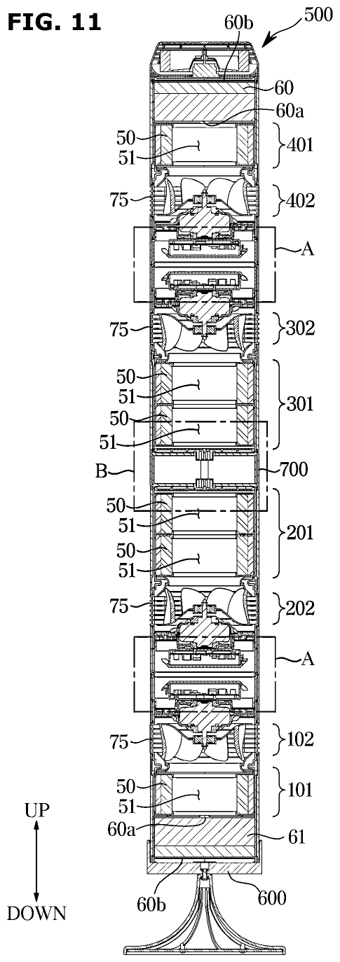

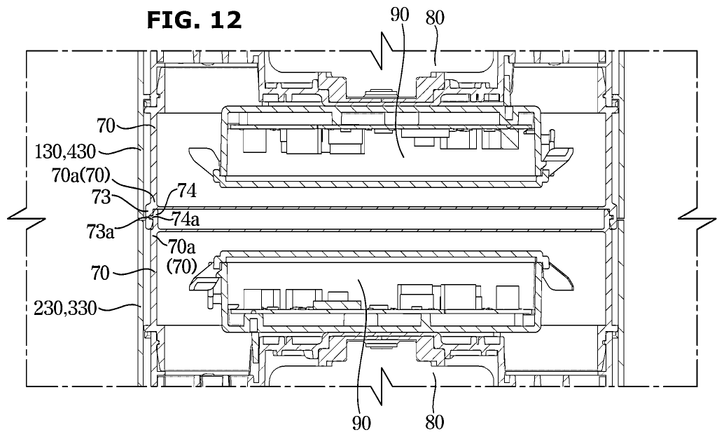

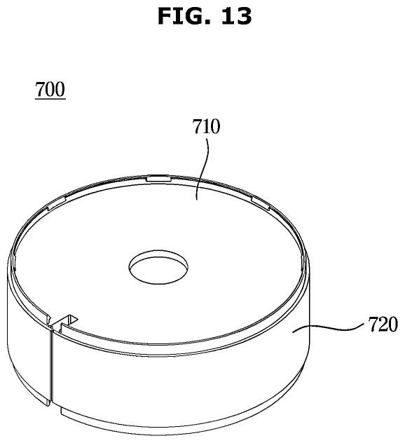

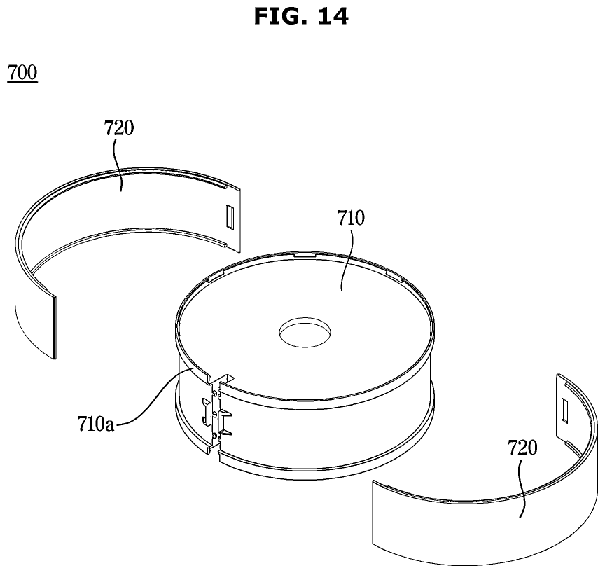

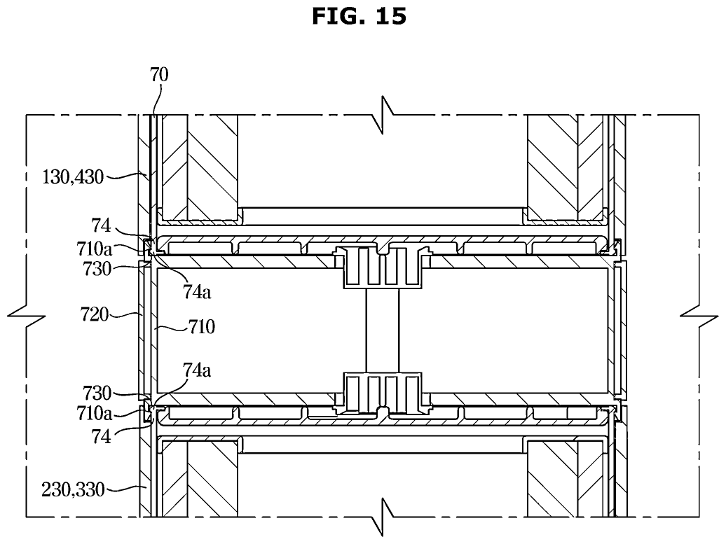

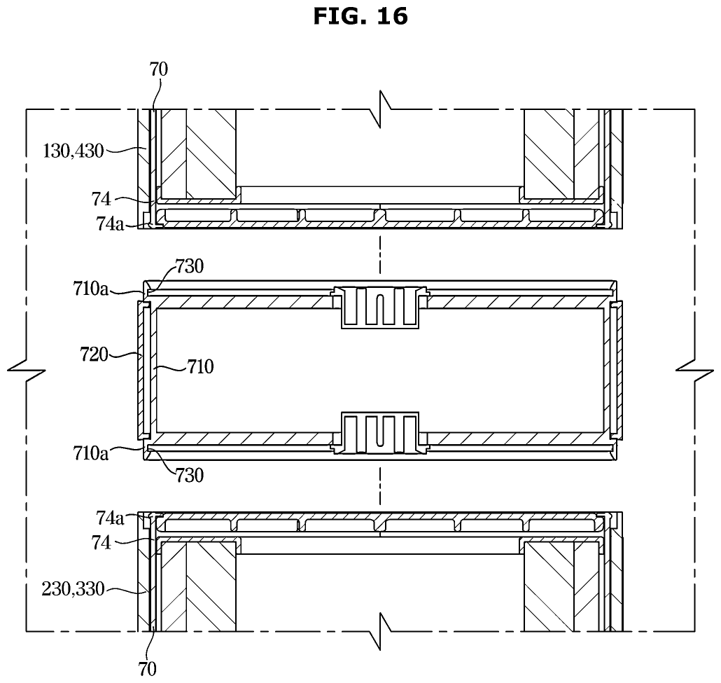

FIG. 11 is a lateral cross-sectional view of the air cleaner according to one embodiment of the present disclosure. FIG. 12 is an enlarged view of areas A of FIG. 11. FIG. 13 is a perspective view of a coupling module of the air cleaner according to one embodiment of the present disclosure. FIG. 14 is an exploded perspective view of the coupling module of the air cleaner according to one embodiment of the present disclosure. FIG. 15 is an enlarged view of area B of FIG. 11. FIG. 16 is a cross-sectional view of a state in which, in FIG. 11, the second air cleaning module and the third air cleaning module are each separated from the coupling module.

Referring to FIG. 11, in the air cleaner 1 according to one embodiment of the present disclosure, a coupling structure between the plurality of air cleaning modules 10, 20, 30, and 40 may be provided as two different structures.

Referring to FIG. 12, the coupling structure between the plurality of air cleaning modules may be provided as a structure in which adjacent air cleaning modules are directly coupled to each other (hereinafter referred to as a direct coupling structure). A fastening groove 73a or a fastening protrusion 74a may be provided at one end of the fan housing 70 of each of the air cleaning modules.

For example, the coupling structure between the plurality of air cleaning modules 10, 20, 30, and 40 may be provided as a structure in which, at the one end 70a of the fan housing 70 of an air cleaning module disposed on top, the fastening groove 73a is formed in an outer flange 73 having the shape of a ring protruding from one side surface of the fan housing 70, and, at the one end of the fan housing 70 of an air cleaning module disposed under the air cleaning module disposed on top, the fastening protrusion 74a is formed on an inner flange 74 protruding from the one side surface of the fan housing 70 to correspond to an inner side surface of the ring-shaped outer flange 73, so that the fastening groove 73a and the fastening protrusion 74a are coupled to each other. However, the present disclosure is not limited thereto, and the air cleaning module including the fan housing 70 in which the outer flange 73 is formed may be disposed under the air cleaning module including the fan housing 70 in which the inner flange 74 is formed.

In another embodiment, the coupling structure between the plurality of air cleaning modules may be provided as a structure in which adjacent air cleaning modules are coupled to each other while an additional structure (the coupling module 700) is present therebetween (hereinafter referred to as a coupling module-added structure).

For example, as illustrated in FIGS. 13 to 15, the coupling structure between the plurality of air cleaning modules 10, 20, 30, and 40 may also be implemented using the coupling module 700 including a coupling frame 710 having a cylindrical shape.

The coupling module 700 may include the coupling frame 710 and a coupling module cover 720. The coupling module cover 720 made of the same material as the first case 130, 430 or the second case 230, 330 for uniformity of the exterior of the air cleaner 1 may be coupled to a circumferential portion of a side surface of the coupling frame 710.

At an upper end or lower end of the coupling frame 710, a fastening groove 730 is formed in an outer flange 710a having the shape of a ring protruding from one side surface of the fan housing 70, and a fastening protrusion 74a is formed on an inner flange 74 protruding from the one side surface of the fan housing 70 to correspond to an inner side surface of the outer flange 710a, so that the fastening groove 730 and the fastening protrusion 74a are coupled to each other.

Referring to FIG. 11, the air cleaning modules in areas A, that is, the coupling structure of the first air cleaning module 10 and the second air cleaning module 20 and the coupling structure of the third air cleaning module 30 and the fourth air cleaning module 40, are illustrated as being coupled by the direct coupling structure, and the air cleaning modules in area B, that is, the coupling structure of the second air cleaning module 20 and the third air cleaning module 30, are illustrated as being coupled by the coupling module-added structure, but the present disclosure is not limited thereto. The coupling module-added structure may be applied to the coupling structures of areas A, and the direct coupling structure may be applied to the coupling structure of area B.

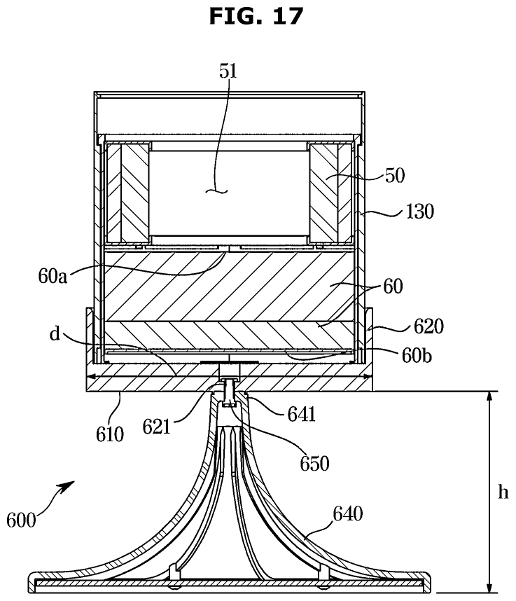

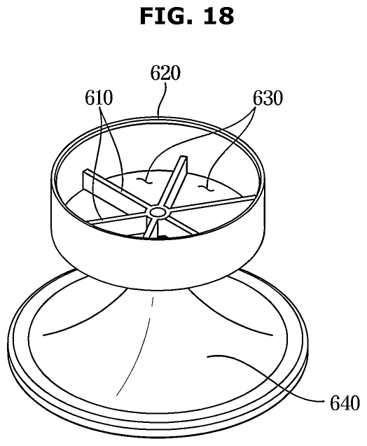

FIG. 17 is a cross-sectional view of a base module and a portion of the first air cleaning module of the air cleaner according to one embodiment of the present disclosure. FIG. 18 is a perspective view of the base module of the air cleaner according to one embodiment of the present disclosure.

The air cleaner 1 according to one embodiment of the present disclosure may further include the module base 600 configured to support the lower end of the first air cleaning module 10.

The module base 600 may include a base plate 610, a base wall 620, and a base support 640. The base plate 610 may be provided in a substantially disk-like shape to correspond to the lower end of the first air cleaning module 10. The base plate 610 may be provided to face the second surface 60b of the plate-shaped filter member 60 of the first air cleaning module 10. The base plate 610 may include a base opening 630 open toward the ground to allow air to be introduced through the second surface 60b of the plate-shaped filter member 60.

Specifically, the base plate 610 may be provided in the shape of a wheel. That is, the base plate 610 may be made of a ring-shaped edge frame and a plurality of bar-shaped frames radially extending toward the ring-shaped edge frame. The base opening 630 may be formed between the radially-extending bar-shaped frames.

However, the shape of the base plate 610 is not limited thereto, and the base plate 610 may be provided so that the disk-shaped plate includes an opening of a specific shape that is open toward the ground. The base wall 620 may be provided in a cylindrical shape extending from the edge of the base plate 610 in a direction away from ground. The base wall 620 may be provided in a shape that corresponds to the lower end of the first air cleaning module 10. The base wall 620 may be provided in a cylindrical shape that surrounds a side surface of the lower end of the first air cleaning module 10. The base wall 620 may be provided in a cylindrical shape that surrounds a side surface of a lower end of the first case 130.

The base support 640 configured to separate the base plate 610 from the ground and support the base plate 610 may be provided under the base plate 610. The base support 640 may be provided in a substantially conical shape. However, the shape of the base support 640 is not limited thereto.

A support fastening groove 641 formed at an upper end of the base support 640 and a plate fastening groove 621 formed at the center of the base plate 610 may be connected, and the base support 640 may be fixed to the base plate 610 by a fastening member 650 passing through the support fastening groove 641 and the plate fastening groove 621.

Referring to FIG. 17, the base plate 610 may be provided to have a diameter d and provided to be spaced apart from the ground by a distance h. In a case in which the distance h from the ground to the base plate 610 is small, flow resistance of air being introduced through the second surface 60b of the plate-shaped filter member 60 may increase. Accordingly, the distance h from the ground to the base plate 610 may be set to be in the following range.

1.3×d/7≤h≤1.3×d/4

Specific embodiments illustrated in the drawings have been described above. However, the present disclosure is not limited to the embodiments described above, and those of ordinary skill in the art to which the disclosure pertains may make various changes thereto without departing from the gist of the technical spirit of the disclosure defined in the claims below.

What is claimed is:

1. An air cleaner comprising:
a first air cleaning module comprising a first body, a first suctioner disposed at a lower portion of the first body, and a first discharger disposed at an upper portion of the first body, wherein the first discharger discharges air that entered into the first suctioner and then passed through a first filter module; and
a second air cleaning module configured to be detachably coupled to an upper end of the first air cleaning module and comprise a second body, a second suctioner disposed at an upper portion of the second body, and a second discharger disposed at a lower portion of the second body, wherein the second discharger discharges air that entered into the second suctioner and then passed through a second filter,
wherein a direction from a position at which the first suctioner is disposed toward a position at which the first discharger is disposed is a first arrangement direction, and
wherein a second arrangement direction, that is a direction from a position at which the second suctioner is disposed toward a position at which the second discharger is disposed, is provided to be the direction opposite to the first arrangement direction.

2. The air cleaner of claim 1, wherein:
the first suctioner is disposed along a circumference of the first body and suctions air inward in a radial direction within a 360° range toward an inside of the first body; and
the first discharger is disposed along the circumference of the first body and discharges air outward in the radial direction within the 360° range toward an outside of the first body.

3. The air cleaner of claim 2, wherein:
the second suctioner is disposed along a circumference of the second body and suctions air inward in the radial direction within the 360° range toward an inside of the second body; and
the second discharger is disposed along the circumference of the second body and discharges air outward in the radial direction within the 360° range toward an outside of the second body.

4. The air cleaner of claim 2, wherein:
the first body further comprises a first fan module;
the first filter module is disposed at the lower portion of the first body to correspond to the first suctioner; and
the first fan module is disposed at the upper portion of the first body to correspond to the first discharger.

5. The air cleaner of claim 3, wherein:
the second body further comprises a second fan module;
the second filter module is disposed at the upper portion of the second body to correspond to the second suctioner; and
the second fan module is disposed at the lower portion of the second body to correspond to the second discharger.

6. The air cleaner of claim 4, wherein:
the first filter module comprises a cylindrical filter member comprising a hollow formed along a central axis thereof and a plate-shaped filter member configured to have a first surface disposed to cover one side of the hollow;
wherein air introduced through a second surface of the plate-shaped filter member, the second surface of the plate-shaped filter member is disposed in a direction opposite to the first surface thereof, passes through the hollow and flows to the second fan module; and
the central axis of the cylindrical filter member is disposed parallel to a direction in which the first suctioner and the first discharger are disposed and allows air introduced into the first suctioner to, from an outer side surface of the cylindrical filter member, pass through the hollow and flow to the first fan module.

7. The air cleaner of claim 6, wherein the first filter module comprises a first filter frame disposed to surround side surfaces of the plate-shaped filter member and the cylindrical filter member and couple the plate-shaped filter member and the cylindrical filter member to each other.

8. The air cleaner of claim 5, wherein:
the second filter module comprises a cylindrical filter member comprising a hollow formed along a central axis thereof;
wherein air introduced through a second surface of the plate-shaped filter member, the second surface of the plate-shaped filter member is disposed in a direction opposite to the first surface thereof, passes through the hollow and flows to the first fan module; and
the central axis of the cylindrical filter member is disposed parallel to a direction in which the second suctioner and the second discharger are disposed and allows air introduced into the second suctioner to, from an outer side surface of the cylindrical filter member, pass through the hollow and flow to the second fan module.

9. The air cleaner of claim 8, wherein:
the cylindrical filter member comprises a plurality of cylindrical filter members; and
the second filter module comprises a second filter frame disposed to surround side surfaces of the plurality of cylindrical filter members and couple the plurality of cylindrical filter members to each other.

10. The air cleaner of claim 7, wherein:
the first filter module and the first fan module are coupled and comprise the first body; and
the first air cleaning module comprises a first case configured to surround a side surface of the first body, in which the first filter module and the first fan module are coupled, to form an exterior of the first air cleaning module, wherein the first case further comprises a first suction port corresponding to the first suctioner and a first discharge port corresponding to the first discharger.

11. The air cleaner of claim 9, wherein:
the second filter module and the second fan module are coupled to constitute the second body; and
the second air cleaning module comprises a second case configured to surround a side surface of the second body, in which the second filter module and the second fan module are coupled, to form an exterior of the second air cleaning module, wherein the second case further comprises a second suction port corresponding to the second suctioner and a second discharge port corresponding to the second discharger.

12. The air cleaner of claim 1, further comprising:
a third air cleaning module comprising a third body, a third suctioner disposed at a lower portion of the third body, and a third discharger disposed at an upper portion of the third body, wherein the third discharger discharges air that entered into the third suctioner and then passed through a second filter; and
a fourth air cleaning module configured to be detachably coupled to an upper end of the third air cleaning module and comprise a fourth body, a fourth suctioner disposed at an upper portion of the fourth body, and a fourth discharger disposed at a lower portion of the fourth body, wherein the fourth discharger discharges air that entered into the fourth suctioner and then passed through a fourth filter,
wherein the third air cleaning module is detachably coupled to an upper end of the second air cleaning module,
wherein a third arrangement direction, that is a direction from a position at which the third suctioner is disposed toward a position at which the third discharger is disposed, is provided to be a direction from a bottom of the air cleaner toward a top thereof, and
wherein a fourth arrangement direction, that is a direction from a position at which the fourth suctioner is disposed toward a position at which the fourth discharger is disposed, is provided to be the direction opposite to the third arrangement direction.

13. The air cleaner of claim 12, wherein:
the third suctioner is disposed along a circumference of the third body and suctions air inward in the radial direction within the 360° range toward an inside of the third body; and
the third discharger is disposed along the circumference of the third body and discharges air outward in the radial direction within the 360° range toward an outside of the third body.

14. The air cleaner of claim 13, wherein:
the fourth suctioner is disposed along a circumference of the fourth body and suctions air inward in the radial direction within the 360° range toward an inside of the fourth body; and
the fourth discharger is disposed along the circumference of the fourth body and discharges air outward in the radial direction within the 360° range toward an outside of the fourth body.

15. The air cleaner of claim 12, wherein at least one of the first body, the second body, the third body, and the fourth body is a cylindrical shape.
